(19) United States
(12) Patent Application Publication
(10) Pub. No.: US 2011/0310980 A1
(43) Pub. Date: Dec. 22, 2011

(54) APPARATUS AND METHODS FOR PROCESSING FRAMES OF VIDEO DATA ACROSS A DISPLAY INTERFACE USING A BLOCK-BASED ENCODING SCHEME AND A TAG ID

(75) Inventor: Mithran Cheriyan Mathew, Mountain View, CA (US)

(73) Assignee: QUALCOMM MEMS TECHNOLOGIES, INC., San Diego, CA (US)

(21) Appl. No.: 12/820,838

(22) Filed: Jun. 22, 2010

(51) Int. Cl. H04N 7/12

(52) U.S. Cl. 375/240.26; 375/E07.076

(57) ABSTRACT

Disclosed are methods, apparatus, and systems, including computer program products, implementing and using techniques for processing frames of video data sent across a display interface using a block-based encoding scheme and a tag ID. The disclosed techniques provide for optimization of the display interface situated between the graphics processor and the display controller of an electronic device. The disclosed techniques minimize the amount of signaling over the interface and reduce the power consumed at the interface. Accordingly, the battery life of some electronic devices can be extended. In one embodiment, the graphics processor is configured to receive frames of video data, where each frame includes one or more blocks of the video data. The graphics processor is configured to encode each block of video data, generate a tag ID associated with each encoded block of video data, and output each encoded block of video data and associated tag ID. The display controller is configured to receive the encoded blocks of video data and associated tag ID's from the graphics processor via the display interface. The display controller is configured to interpret the tag ID associated with a respective encoded block of video data and determine whether to decode at least part of the respective encoded block of video data according to the tag ID. A display, such as a memory-based display, is in communication with the display controller. The display is configured to receive and display decoded blocks of video data from the display controller.

### FIELD

This application relates generally to display technology and more specifically to circuitry for controlling displays.

### DESCRIPTION OF RELATED TECHNOLOGY

Power consumption is a concern with modern electronic devices, particularly portable handheld devices. Battery-powered cell phones and wireless electronic reading devices incorporating conventional display technologies require frequent re-charging of the batteries, in some cases, several times in a single day. The need to constantly re-charge such devices interferes with their fundamental purpose, that is, to allow a user to continue using them (i.e., not be interrupted to have to re-charge them) as the user moves from place-to-place throughout the day.

A significant amount of power, often the majority of power, is consumed by the displays in many modern portable electronic devices for certain applications. Currently, the majority of displays used on mobile devices are Liquid Crystal Displays (LCDs), which require continuous updates of video data to maintain the video output on the display. Electronic reading devices with bi-stable displays do not require continuous updates but still consume an unacceptable amount of power. The power across a display interface tends to be high, particularly for larger displays. Indeed, the power required by active display interfaces in modern devices is growing rapidly, particularly as display resolutions increase for these devices. The power consumed by the display interface is generally proportional to the square of the switching voltage, the frequency of the display data, and the capacitance of the interconnect lines of the interface.

Thus, an overall concern with modern electronic devices is conservation of power used to drive the displays.

### SUMMARY

Disclosed are methods, apparatus, and systems, implementing and using techniques for processing frames of video data sent across a display interface using a block-based encoding scheme and tag ID's.

Some aspects of the present application incorporate techniques which cooperate with a host element, often in the form of a graphics processor or controller, and a display element, often in the form of a display controller which drives a display. A display interface connects the graphics processor with the display controller. The disclosed apparatus and methods provide for the compression of video data at the host element, before it is sent across the display interface, and then the de-compression of this data at the display element.

The display interface is traditionally viewed as a physical layer or connection between the host element and the display element. Some aspects of the present application are based on a logical view of the display interface. Logical operations can be performed to organize and transmit the data across the display interface. These operations are applicable to various physical interfaces and connections. Regardless of the physical nature of the display interface layer, applying techniques disclosed herein, video data can be encoded on the graphics processor side of the interface and selectively decoded at the display controller side after it is sent across the interface. The decoded data is, accordingly, selectively output from the display controller to the display.

Some aspects of the present application provide for optimization of the display interface, situated between the graphics processor and the display controller of an electronic device. The optimization techniques described herein minimize the amount of signaling over the interface and reduce the power consumed at the interface. Accordingly, the battery life of some electronic devices can be extended.

According to one aspect of the present application, an apparatus comprises a graphics processor configured to receive frames of video data. Each frame includes one or more blocks of the video data. The graphics processor is configured to encode each block of video data and generate a tag ID associated with each encoded block of video data. The graphics processor is configured to output each encoded block of video data and associated tag ID. A display interface is in communication with the graphics processor. A display controller is in communication with the display interface. The display controller is configured to receive the encoded blocks of video data and associated tag ID's from the graphics processor via the display interface. The display controller is configured to interpret the tag ID associated with a respective encoded block of video data and determine whether to decode at least part of the respective encoded block of video data according to the tag ID. A display, such as a memory-based display, is in communication with the display controller. The display is configured to receive decoded blocks of video data from the display controller and to display the decoded blocks of video data.

According to one implementation, the tag ID can include one or more indications such as: a start of a new frame of video data, a redundant frame of video data, a start of a new block of video data, and a redundant block of video data. For instance, the display controller can be configured to disregard the encoded block of video data if the tag ID indicates a start of a redundant block of video data.

Depending on the desired implementation, the graphics processor can be configured to encode the blocks of video data using processing techniques such as Run Length Encoding (RLE), Arithmetic Coding (AC), or Huffman Coding (HC).

According to one implementation, the display is a bi-stable display such as: an interferometric modulation display (IMOD), a cholesteric liquid crystal display (ChLCD), or an electrophoretic display.

Depending on the desired implementation, the display interface can be configured to pass the encoded blocks of video data using a standard such as: the Mobile Industry Processor Interface (MIPI) standard, the Mobile Display Digital Interface (MDDI) standard, the Low-Voltage Differential Signaling (LVDS) standard, or the High-Definition Multimedia Interface (HDMI) standard.

Another aspect of the present application relates to a method in which each block of video data is encoded. Tag ID's associated with each encoded block of video data are generated. For instance, the tag ID can be generated by performing a compare operation between successive blocks of video data. Encoded blocks of video data and associated tag ID's are provided from the graphics processor to a display interface in communication with the graphics processor. A display controller in communication with the display interface receives the encoded blocks of video data and associated tag ID's. The tag ID associated with a respective encoded block of video data is interpreted. It is determined whether to decode at least part of the respective encoded block of video data according to the tag ID. Decoded blocks of video data are provided from the display controller to a display in communication with the display controller. The display is configured to display the decoded blocks of video data.

These and other methods and apparatus of aspects of the present application may be implemented using various types of hardware, software, firmware, etc., and combinations thereof. For example, some features of the application may be implemented, at least in part, by computer programs embodied in machine-readable media. The computer programs may include instructions for operating, at least in part, the devices described herein. These and other features and benefits of aspects of the application will be described in more detail below with reference to the associated drawings.

### BRIEF DESCRIPTION OF THE DRAWINGS

The included drawings are for illustrative purposes and serve only to provide examples of possible structures and process steps for the disclosed methods, apparatus, and systems for processing frames of video data sent across a display interface using a block-based encoding scheme and a tag ID.

FIG. 1 is a block diagram of an electronic device for processing a sequence of frames of video data across a display interface using a block-based encoding scheme and a tag ID, constructed according to one embodiment.

FIG. 2 is a block diagram of an alternative embodiment of an electronic device for processing a sequence of frames of video data across a display interface using a block-based encoding scheme and a tag ID.

FIG. 3 is a diagram illustrating a packet of a compressed block of video data in a frame using a Run Length Encoding (RLE) scheme and a tag ID, in accordance with one embodiment.

FIG. 4 is an illustration of a set of tag ID parameters in a compressed block of video data, in accordance with one embodiment.

FIG. 5 is a flow diagram of a method for processing a sequence of frames of video data across a display interface using a block-based encoding scheme and a tag ID, performed in accordance with one embodiment.

FIG. 6 is a flow diagram of a method for determining whether to decode an encoded block of video data according to a tag ID, performed in accordance with one embodiment.

FIG. 7 is a system block diagram illustrating one embodiment of an electronic device incorporating an interferometric modulator display.

FIGS. 8A and 8B are system block diagrams illustrating an embodiment of a visual display device comprising a plurality of interferometric modulators.

### DETAILED DESCRIPTION

While the present application will be described with reference to a few specific embodiments, the description and specific embodiments are merely illustrative and are not to be construed as limiting. Various modifications can be made to the described embodiments without departing from the true spirit and scope as defined by the appended claims. For example, the steps of methods shown and described herein are not necessarily performed in the order indicated. It should also be understood that the methods may include more or fewer steps than are indicated. In some implementations, steps described herein as separate steps may be combined. Conversely, what may be described herein as a single step may be implemented in multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa. Moreover, the specific components, parameters, and numerical values described herein are provided merely by way of example and are in no way limiting. The drawings referenced herein are not necessarily drawn to scale.

Embodiments of the present application overcome some of the drawbacks of conventional electronic devices, by reducing the amount of power consumed at the display stage. By incorporating embodiments of the present application, electronic devices are able to reduce this power drain, which is a significant component of the overall power consumption of the device. Thus, some of the features described herein provide for a longer lasting memory display, such as a bi-stable display, for instance, in a battery-powered mobile reading device.

The apparatus and methods described herein leverage the characteristics of both the content of the video data being transmitted as well as the features of memory displays. As used herein, “memory display” refers to any display having a memory function, that is, where the display is capable of retaining displayed video data. Examples of suitable memory displays include bi-stable displays as well as other types of displays incorporating memory devices such as frame buffers. With respect to the content, one technique involves the use of tag ID's associated with blocks of video data sent across the display interface. Embodiments of the present application can use a block-based approach to sending data across the display interface, in which individual blocks of pixels within a frame of video data are processed. A tag ID generator is provided on the graphics processor side of the display interface, as further explained below, and a counterpart tag ID reader is located on the display controller side. The tag ID generator generates a tag ID for unique blocks of video data being sent. The tag ID reader interprets the tag ID to determine whether to write a particular block to the display.

A second technique described herein uses a block-based encoder, for instance, a Run Length Encoder on the graphics processor side, and a counterpart block-based decoder on the display controller side of the display interface. In some implementations, Run Length Encoding (RLE) is desirable because it is lossless, meaning no loss is introduced by the encoding scheme in signals sent from the graphics processor to the display controller. In addition, RLE is desirable because it can be simple to implement, thus reducing code delay and processing power. In some embodiments, RLE is performed according to color of the pixels. The data in images, particularly in sub-portions or blocks of the image is often correlated by color. Thus, higher encoding and decoding efficiency can be achieved by grouping red, green, and blue pixels together, for example. Also, depending on the desired implementation, raster scanning or serpentine scanning can be used to read and encode the pixel value colors row-by-row or in some other sequence within a block.

Different encoding and decoding schemes can be incorporated into embodiments of the present application, as an alternative to RLE. Examples of such schemes include Arithmetic Coding (AC) and Huffman Coding (HC). AC and HC are useful in some implementations in which more compression is desired.

In one embodiment, the encoder is configured to encode m×n blocks within in each frame of video data. The m×n block could be variable or fixed size, depending on the implementation. Also, when implementing block-based encoding and decoding in this manner, tradeoffs can be made between memory size code delay, implementation delay, and compression efficiency, by varying the m×n size. Encoding successive blocks of pixel data in this manner can take advantage of spatial correlation and colors in most images, thus significantly reducing the size of the data to send across the display interface. For instance, for each m×n block, a Run Length Encoded packet can be generated and sent to the display controller. The block-based decoder is configured to decode and output the data in the packet when the associated tag ID indicates it is appropriate to do so.

Other apparatus and methods in addition to the use of tag ID's and block-based encoding/decoding are disclosed herein. The embodiments incorporating the various features are applicable to a variety of displays, but are particularly beneficial for memory-based display technology. For instance, because bi-stable displays have a memory state, bi-stable displays do not have a requirement on the display controller to provide continuous updates of video data to the display. Bi-stable displays can afford some latency. Thus, the display controller need not decode and output every block or frame of data it receives when the data is redundant, i.e., a copy of previously received data for the region of the display corresponding to the received block. Also, using RLE in combination with memory-based displays facilitates the handling of “bursty” data signals, i.e., including data which is uneven in nature.

Embodiments of the present application can be incorporated in a variety of modern electronic devices, particularly those in which it is desirable to incorporate energy-efficient bi-stable displays, such as Interferometric Modulator Displays (IMODs), Cholesteric LCDs (ChLCDs), electrophoretics (e-ink), and other displays that have bi-stable properties. The techniques described herein optimize the architecture of graphics processors and display controllers for such displays. The amount of signaling required between the graphics processor and the display controller, i.e., over the display interface, is reduced to lower the overall energy consumption of the device.

Embodiments of the present application can be incorporated into electronic devices having other types of memory displays, i.e., displays having a frame buffer or other memory unit local to the display so that incoming video data can be buffered. For instance, as described in greater detail below, a frame buffer can be provided on the display controller side of the display interface and used to buffer data provided from the display controller to the display.

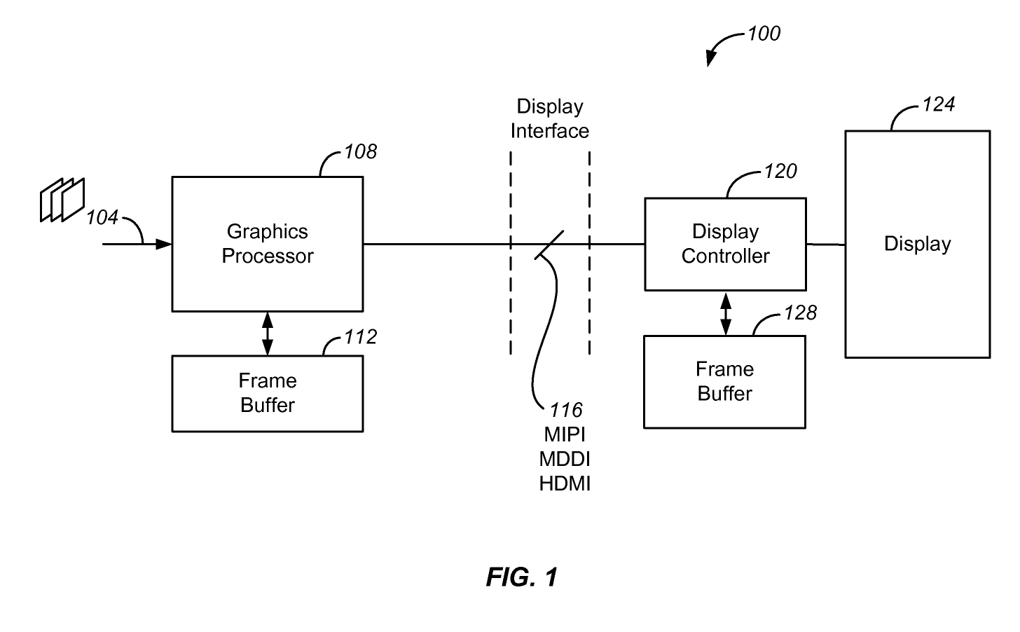

FIG. 1 is a block diagram of an electronic device 100 for processing a sequence of frames of video data across a display interface using a block-based encoding scheme and a tag ID, constructed according to one embodiment. In FIG. 1, a stream of video data 104 is provided as an input to a graphics processor 108. The graphics processor 108 is in communication with a frame buffer 112 implemented, for example, as a bank of SDRAM. In this way, as the graphics processor 108 receives frames of input video data 104, graphics processor 108 is capable of storing the frames in frame buffer 112.

In FIG. 1, graphics processor 108 is in communication with a display interface 116. Video data that has been processed by graphics processor 108, using techniques described herein, is output from graphics processor 108 to display interface 116 for passing the processed data over one or more communications lines to a display controller 120, also in communication with display interface 116.

In FIG. 1, depending on the desired implementation, display interface 116 can be configured according to a particular communications standard, such as the Mobile Industry Processor Interface (MIPI) standard, the Mobile Display Digital Interface (MDDI) standard, and the High-Definition Multimedia Interface (HDMI) standard. An example of a suitable bandwidth of the display interface 116 is in the range of 6-24 bits wide. However, features of the present application are applicable to display interfaces of other suitable bandwidths.

The MIPI standard, which is a serial interface providing differential signaling, is a common interface standard for electronic devices with smaller displays, for instance, cell phones. In such implementations, the bandwidth of the display interface 116 can be relatively smaller, for instance, 6 bits wide. MDDI is another standard used for electronic devices 100 with smaller displays. The encoding and selective decoding techniques using tag ID's, as described herein, are equally applicable to electronic devices having larger displays, such as those having an HDMI standard at display interface 116.

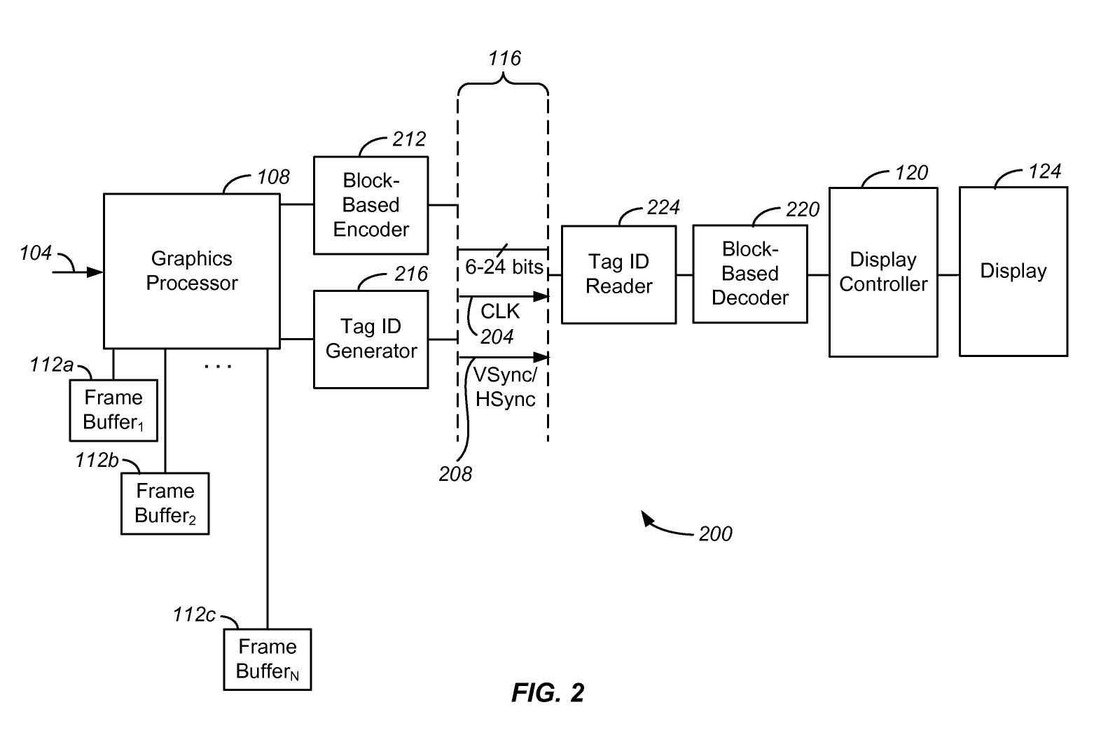

As shown in the embodiment of FIG. 2, described in greater detail below, the communications lines comprising display interface 116 include a clock signal line 204 (“CLK”) and one or more other control signal lines 208, for instance, providing vertical and horizontal synchronization signals, “VSync” and “HSync,” respectively. These communications lines illustrated in FIG. 2 represent one physical implementation of display interface 116 as an RGB interface, in which red, green, and blue data is provided over the 6-24 bit data channel mentioned above.

In another embodiment, for instance, when display interface 116 is implemented in accordance with the MIPI or the Low-Voltage Differential Signaling (LVDS) standard, interface 116 can have a different physical configuration. When LVDS is used, a serializing transmitter and a de-serializing receiver can be situated on opposite sides of display interface 116. The transmitter would encode the video data and clock signal to be sent over interface 116 into a differential serial signal. The receiver would be operatively coupled on the display controller side to receive differential data sent over interface 116, perform serial to parallel conversion of the data, and provide the converted data to the display controller. In other implementations, display interface 116 can be configured as a memory-mapped interface, for instance, with a multiplexed address and data bus.

In FIGS. 1 and 2, the disclosed techniques for encoding and selectively decoding video data using tag ID's are applicable to a variety of configurations of display interface 116. As mentioned above, this represents an improvement over conventional schemes, in which no compression is applied to data sent across a display interface. With conventional devices, the data sent across a display interface is uncompressed, irrespective of the standard according to which the display interface might be configured. In FIGS. 1 and 2, the techniques disclosed herein provide for encoding and selective decoding of data, which can be transmitted across display interface 116 in serial fashion and with differential signaling.

Returning to FIG. 1, display controller 120 is in communication with a display 124, which may be an LCD display, in one embodiment, or a memory display such as a bi-stable display, in another embodiment. The display controller 120 drives display 124 so that display 124 is capable of displaying video data received from display controller 120. In the case of a bi-stable display, display 124 can be constructed as an IMOD, a ChLCD, or an electrophoretic display. In one embodiment, display controller 120 and display 124 are in communication with a frame buffer 128 or other suitable memory unit in which processed data can be stored by controller 120 before being output to display 124. In one implementation, the display controller 120, frame buffer 128, and display 124 can be constructed as an integral unit.

FIG. 2 shows a block diagram of an alternative embodiment of an electronic device 200 for processing a sequence of frames of video data across a display interface, constructed according to another embodiment. The electronic device 200 of FIG. 2 is similar to electronic device 100 of FIG. 1 in most respects, with like reference numerals indicating like parts in the respective diagrams. FIG. 2 illustrates separate modules, which provide the solutions of encoding and selective decoding of data, as well as the generation and reading of tag ID's associated with packets of data sent across display interface 116. In particular, one of the solutions described herein adds a block-based encoder 212 and a tag ID generator 216 to the graphics processor side of display interface 116, while a counterpart block-based decoder 220 and tag ID reader 224 are added on the display controller side of interface 116. The block-based encoder 212 and tag ID generator 216 can be constructed as separate modules apart from graphics processor 108, as shown in FIG. 2. Similarly, block-based decoder 220 and tag ID reader 224 can be constructed as separate modules from display controller 120, as illustrated. Alternatively, modules 212 and 216 can be integrated as processing units of graphics processor 108, as shown in FIG. 1. By the same token, block-based decoder 220 and tag ID reader 224 can be integral processing units of display controller 120 in the embodiment of FIG. 1.

In one embodiment, block-based encoder 212 and block-based decoder 220 cooperate to encode and decode blocks of video data using the RLE scheme. RLE is a form of encoding in which runs of data, that is, sequences in which the same pixel value occurs in consecutive data elements, are stored as a single data value and count, rather than as the original run.

As described in further detail below, the RLE scheme can be applied to portions of a frame of video data to be transmitted across display interface 116. Using the RLE scheme in this manner saves energy by reducing the amount of data sent over display interface 116. Block-based encoder 212 can apply the RLE technique or other encoding schemes to take advantage of spatial correlations in the video data to compress the data before sending it. For example, a frame of video data retrieved by graphics processor 108 can be separated into 8×8 blocks. Thus, for instance, an all black image in a particular 8×8 block of pixels could be encoded by block-based encoder 212, applying the RLE scheme, as an L64c0x0 or length 64, color 0 (black) sequence. Thus, for a black block of 8×8 pixels, the RLE scheme saves 192 bytes of data, assuming the data is 24 bits. The handling of video data in frames and division into blocks is described in greater detail below.

In FIG. 2, frame buffer 112 of FIG. 1 has been implemented as a plurality of frame buffers 112a-112c. Separate frame buffers 112a-112c can be used by graphics processor 108 to store and retrieve separate frames of video data. In addition, graphics processor 108 can perform operations on the separate frames of video data and store resulting calculations, such as comparison data, in different locations within the frame buffer array 112a-112c, as described herein. Frame buffers 112a-112c can be located off-chip from graphics processor 108 or, alternatively, formed as integral units with processor 108, depending on the desired implementation.

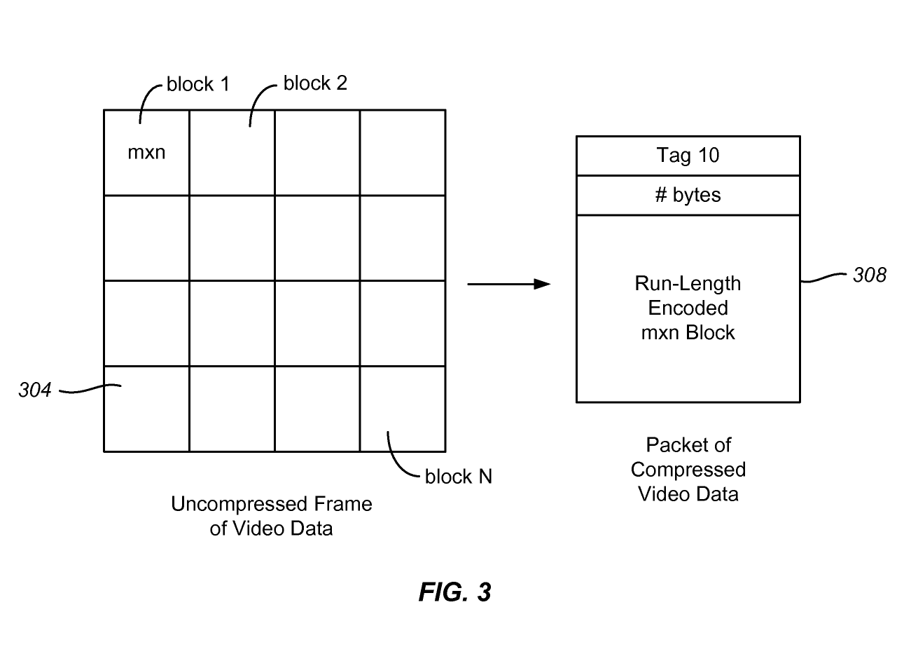

FIG. 3 is a diagram illustrating the conversion of blocks of video data in a frame to compressed packets using RLE and tag ID's, in accordance with one embodiment. In FIG. 3, an uncompressed frame 304 of video data is retrieved from one of frame buffers 112a-112c by graphics processor 108 of FIG. 2. Graphics processor 108 is configured to divide frame 304 into a total of N individual blocks (block 1, block 2, . . . block N) of a designated m×n size. The block-based encoder 212 is configured to encode each individual m×n block of pixels as part of a compressed packet 308, as shown in FIG. 3. Often, the encoded packet 308 will also include an “escape” character to indicate to the decoder that the end of the block has been reached. The escape character can be implemented in different manners, often depending on the format of the data being sent. Such an escape character or other limiting mechanism can serve to limit memory usage on the display controller side of interface 116.

The tag ID generator 216 is configured to generate a tag ID with each encoded block of video data. The tag ID, in the embodiment of FIG. 3, is included at the beginning or top of the header of packet 308, as shown in FIG. 3, to indicate the type of data included in packet 308. In addition, graphics processor 108 of FIG. 2 is configured to identify a number of bytes in the compressed block 308 and also include this information in the header, as shown in FIG. 3. Thus, on the receiving side of display interface 116, display controller 120 can immediately determine the size of packet 308 in addition to the type of data indicated by the tag ID.

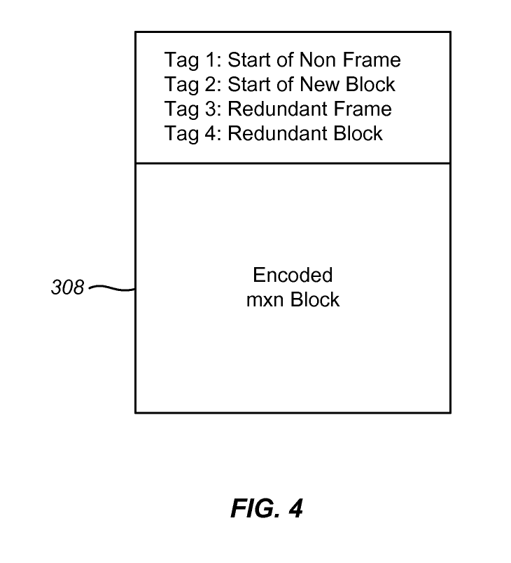

FIG. 4 is an illustration of a set of possible tag ID parameters in a compressed packet 308, in accordance with one embodiment. Applying techniques described herein, the tag ID generator 216 associated with graphics processor 108 is capable of generating a variety of tag parameters to identify the type of data included in the associated encoded m×n block of data within packet 308. For instance, as shown in FIG. 4, the tag ID component of packet 308 can indicate whether the included block represents the start of a new frame of video data or a redundant frame of video data. In addition, the tag ID can indicate the start of a new block of video data within a frame, as well as whether the encoded block is redundant in view of the previous block. In this way, on the display controller side of display interface 116, responsive to tag ID reader 224 processing one or more of the tag ID's of FIG. 4, the display controller can determine whether to decode the included block of encoded video data, as further described below. For instance, when the tag ID at the beginning of a packet 308 indicates that the encoded block is redundant, display controller 120 can disregard the included data. That is, since the previous block is the same, the new block does not need to be output to display 124.

In FIG. 4, the tag ID component of packet 308 can be represented as a sequence of bits to indicate one or more of the tag ID parameters. For instance, the four tag ID parameters described and illustrated in FIG. 4 could be represented with a 2-bit code (e.g., 00, 01, 10, 11). More common allocations for the tag ID are 4-bit wide and 8-bit wide values. In most implementations, the tag ID is preferably as wide as the rest of the video data being sent in packet 308. The width of the tag ID in packet 308 can have other sizes, depending on the desired implementation. In a 4-bit wide implementation, a respective bit could indicate a respective one of the tag ID's shown in FIG. 4. For instance, a “1100” tag ID could indicate that the encoded block represents both the start of a new frame and the start of a new block of video data to be displayed.

The operations carried out to generate tag ID's at graphics processor 108 and read tag ID's at display controller 120 are described in further detail below, following a general discussion of embodiments of methods for encoding and selectively decoding blocks of video data using the apparatus of FIGS. 1 and 2.

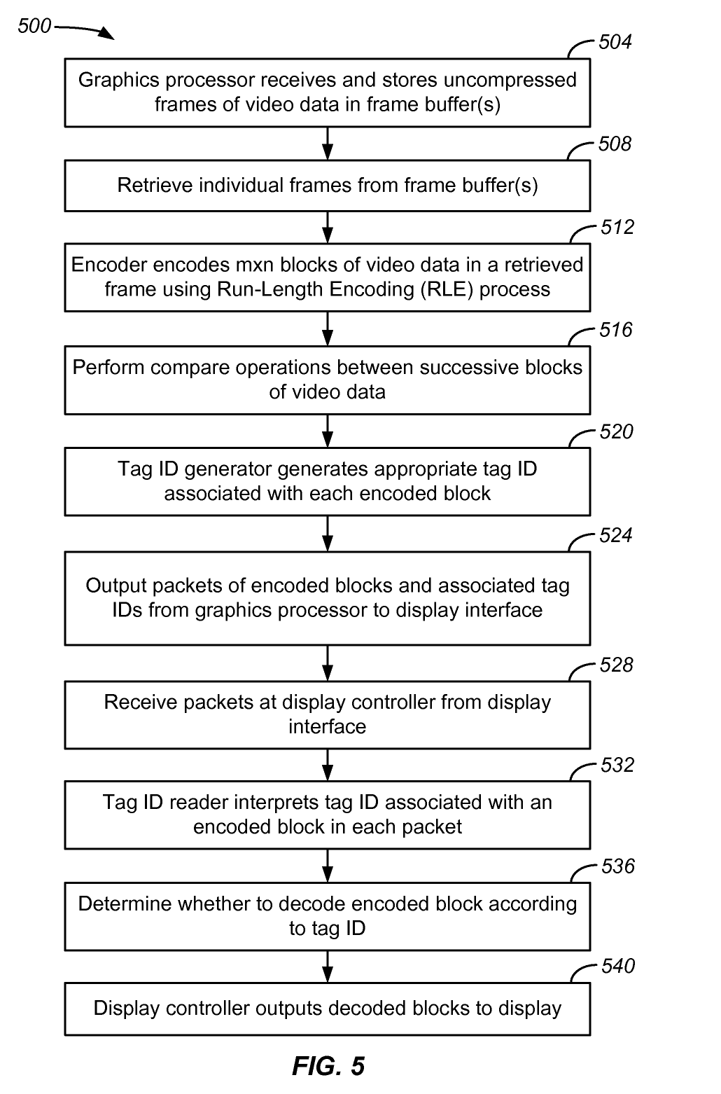

FIG. 5 shows a flow diagram of a method 500 for processing a sequence of frames of video data across a display interface, performed in accordance with an embodiment of the present application. The operations of method 500 are described primarily with reference to the apparatus of FIG. 2, but should be understood to equally apply to electronic device 100 of FIG. 1. In 504, graphics processor 108 receives a stream of input video data 104 and stores frames of the sequence in one or more frame buffers 112a-112c. In 508, graphics processor 108 is capable of retrieving individual frames from frame buffers 112a-112c for processing. In 512, once a frame is retrieved by graphics processor 108, block-based encoder 212 can apply RLE or another encoding scheme describe herein to encode m×n blocks of data in the frame, as illustrated in FIG. 3. In 516 and 520, tag ID generator 216 is configured to generate an appropriate tag ID to associate with individual blocks encoded by encoder 212. In one embodiment, in 516, compare operations can be performed between successive blocks of video data in a frame to determine the appropriate tag ID.

In FIG. 5, in 516, logic can be implemented and configured at graphics processor 108 to compare successive blocks of data to determine an appropriate tag ID. In one embodiment, for example, a sequence of blocks within a frame can be identified by memory addresses within one or more of the frame buffers 112a-112c. As individual blocks in a sequence are retrieved by graphics processor 108, pixel values of two blocks in a sequence can be compared to determine whether the data is redundant or new. A similar set of logic at graphics processor 108 can be applied to respective frames in a sequence to similarly identify redundant frames and set the appropriate tag ID, as shown in FIG. 4. Separate frame buffers can be used to do the comparisons. For example, the first frame or block in a sequence could be stored in frame buffer 112a, the second frame or block in a sequence stored in buffer 112b, and the output of the compare operation could be stored in buffer 112c.

In FIG. 5, in 520, tag ID generator 216 is capable of outputting the appropriate tag ID responsive to the operations performed in 516. In this way, in 524, graphics processor 108 outputs packets of respective encoded blocks and associated tag ID's, as illustrated in FIG. 3, to display controller 120 via display interface 116. Over time, sequences of encoded blocks and tag ID's are sent across display interface 116.

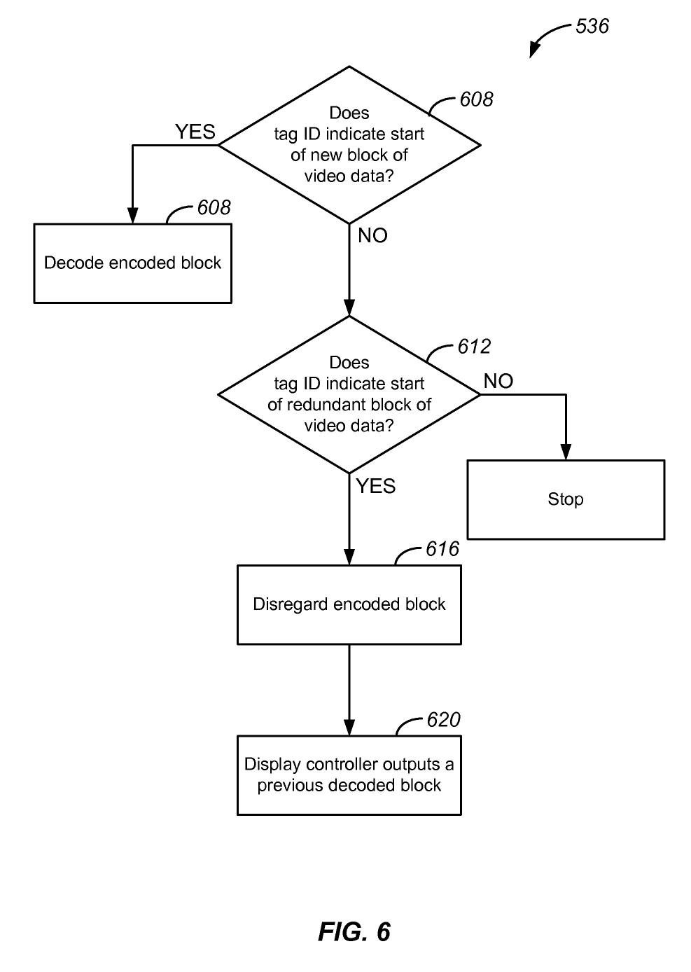

In FIG. 5, in 528, on the other side of display interface 116, display controller 120 receives the encoded packets. In 532, tag ID reader 224 interprets the tag ID associated with each encoded block in the packet. In 536, based on the tag ID parameter, as illustrated in FIG. 4, display controller 120 can then determine whether to decode the associated encoded block of data. This determination in 536 is described in further detail below, with reference to FIG. 6. In 540, depending on the determination made in 536, display controller 120 is configured to output decoded blocks of video data to display 124.

FIG. 6 shows a flow diagram of a method 536 for determining whether to decode an encoded block of video data according to a tag ID. In 604, display controller 120 checks to see whether the tag ID indicates the start of a new block of video data, for instance, if tag 2 in FIG. 4 has a “1” or “On” value. If so, in 608, block-based decoder 220 will decode the block of data. Thus, in general, as packets of encoded data are received on the display controller side, tag ID reader 224 will process the first byte of the packet, which is generally the tag ID. The decoder 220 will respond according to what the tag indicates. Thus, in 612, display controller 120 is configured to check whether the tag ID indicates the start of a redundant block of video data. If so, in 616, display controller 120 will ignore the block. Often, when a block is ignored, in 620, display controller 120 is configured to output the previous decoded block in the sequence of received packets, since the data in the blocks are the same. In this instance, display controller 120 will still update display 124, but is using existing information that was decoded and displayed in the last cycle, i.e., when the previous block was processed. The data is essentially copied for the present cycle.

Thus, in FIGS. 5 and 6, block-based decoder 220 is triggered to decode new blocks of data and ignore redundant blocks of data, according to what the tag ID attached to each block indicates. The block-based decoder 220 is triggered to decode the appropriate blocks by display controller 120.

Returning to FIGS. 3 and 4, in one embodiment, the first byte in each compressed packet is the unique tag ID. In this way, as tag ID reader 224 of FIG. 2 receives and processes sequences of blocks, tag ID reader 224 can identify the tag ID as the initial data in the packet. Block-based decoder 220 can then decode new blocks of data and store the decoded data in a line buffer as RGB data to be output to display 124.

In FIGS. 1 and 2, the apparatus comprising electronic devices 100 and 200 is primarily implemented in hardware. Certain mechanisms and operations described herein could be implemented in software or in combinations of hardware and software. In certain hardware implementations, in which the graphics processor 108, encoder 212, and tag ID generator 216 are implemented on the same chip, the operations and interactions of these components can be more optimized and efficient, thus consuming less power. For instance, graphics processor 108 could be implemented as an ASIC with a video compression module to implement block-based encoder 212 and tag ID generator 216. Similarly, on the display controller side, block-based decoder 220 and tag ID reader 224 could be integrated with display controller 120 in a single chip or circuit. Thus, on the display controller side, additional power savings and optimization can be achieved, contributing to the overall efficiency of electronic devices 100 and 200.

Implementations of the methods and apparatus described herein provide for reducing the amount of data sent across display interface 116. The amount of active time that the CLK signal 204 of FIG. 2 needs to be on is reduced. This represents a significant reduction in the amount of power consumed at display interface 116.

Embodiments of the methods and apparatus described herein bring the power-saving benefits of compression and decompression to the display interface 116. The techniques described herein do so without much cost in the way of additional circuitry, as illustrated by the incorporation of the block-based encoder and tag ID generator in graphics processor 108 and incorporation of block-based decoder 220 and tag ID reader 224 into display controller 120, as shown in FIG. 1. RLE and tag ID capabilities can be built into integrated circuits so the resulting chip real estate is small and has little additional cost.

Using the block-based approaches described herein provide opportunities for exploiting areas of a display screen that have redundant content. This is to be contrasted with raster scan technology used in display interfaces, thus maximizing the benefit for bi-stable and other memory-based displays. For instance, with video signals having primarily textual content, the display interface write time could be reduced by 30-50%. Reducing the write time at the display interface corresponds to a reduction in time that the interface is required to be active. The power consumption of the various components active on both sides of display interface 116 is also reduced.

The embodiments described herein may be implemented in any electronic device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry).

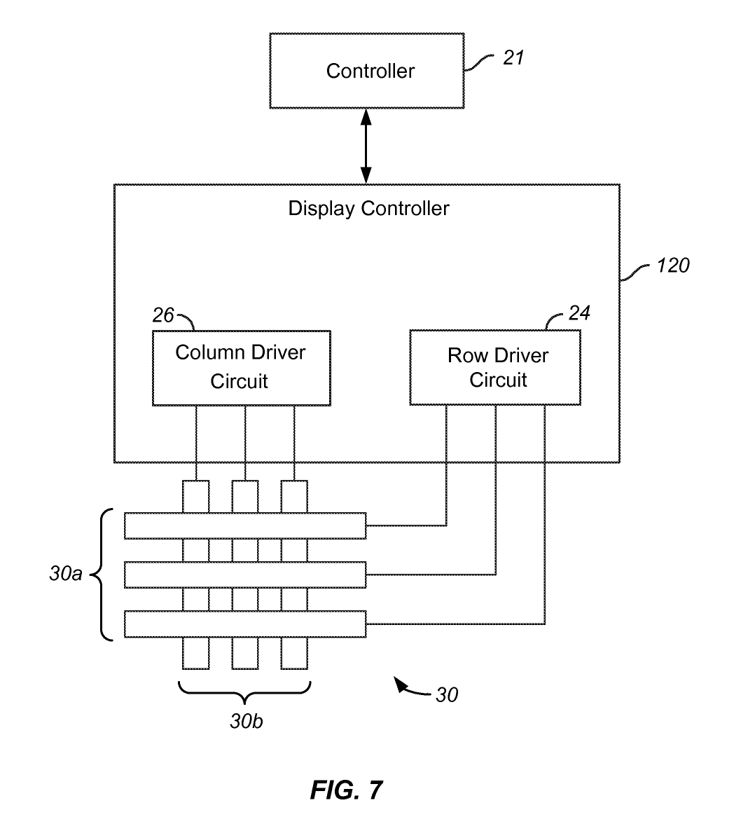

FIG. 7 is a system block diagram illustrating one embodiment of an electronic device that may incorporate apparatus described herein. The electronic device may, for example, form part or all of a portable display device such as a portable media player, a smartphone, a personal digital assistant, a cellular telephone, a smartbook or a netbook. Here, the electronic device includes a controller 21, which may include one or more general purpose single- or multi-chip microprocessors such as an ARM®, Pentium®, 8051, MIPS®, Power PC®, or ALPHA®, or special purpose microprocessors such as a digital signal processor, microcontroller, or a programmable gate array. Controller 21 may be configured to execute one or more software modules. In addition to executing an operating system, the controller may be configured to execute one or more software applications, including a web browser, a telephone application, an email program, or any other software application. The graphics processor 108 of FIGS. 1 and 2 can be implemented as a module of controller 21.

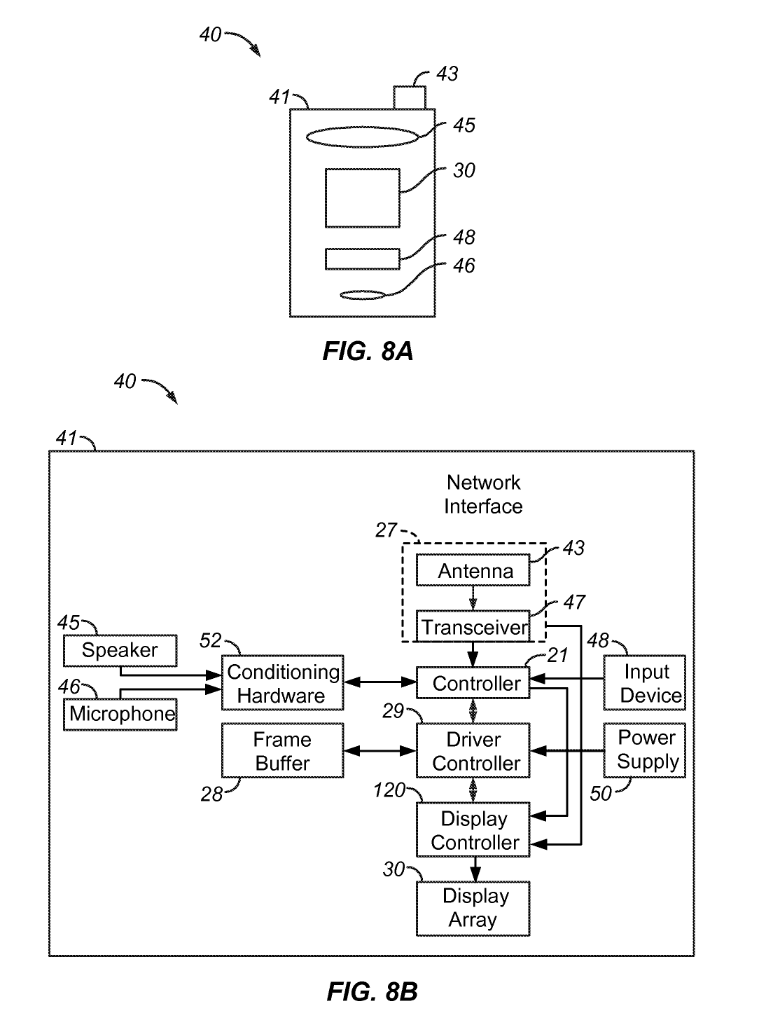

The controller 21 is configured to communicate with a display controller 120, as shown in FIGS. 1 and 2, and in FIGS. 7 and 8. In one embodiment, the display controller 120 includes a row driver circuit 24 and a column driver circuit 26 that provide signals to a display array or panel 30. The display controller 120 generally includes driving electronics for driving the display array 30. Controller 21 and display controller 120 may sometimes be referred to herein as being “logic devices” and/or part of a “logic system.” Note that although FIG. 7 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column). The display array 30 has rows 30a and columns 30b comprising the 3×3 or other size array of modulators.

FIGS. 8A and 8B are system block diagrams illustrating an embodiment of a display device 40, as one example of an electronic device 100 or 200, as described above. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable or other memory display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 8B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a controller 21, which is connected to conditioning hardware 52. The conditioning hardware 52 may be configured to condition a signal (e.g. filter a signal). The conditioning hardware 52 is connected to a speaker 45 and a microphone 46. The controller 21 is also connected to an input device 48 and a driver controller 29. The driver controller 29 is coupled to a frame buffer 28, and to a display controller 120, which in turn is coupled to a display array 30. Conditioning hardware 52 and/or driver controller 29 may sometimes be referred to herein as part of the logic system. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the controller 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the controller 21. The transceiver 47 also processes signals received from the controller 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the controller 21. For example, the image source can be a digital video disc (DVD) or a hard-disc drive that contains image data, or a software module that generates image data.

Controller 21 generally controls the overall operation of the exemplary display device 40. The controller 21 receives data, such as compressed image data from the network interface 27 or an image source, and processes the data into raw image data or into a format that is readily processed into raw image data. The controller 21 then sends the processed data to the driver controller 29 or to frame buffer 28 for storage. Raw data refers to the information that identifies the image characteristics at each location within an image. For example, such image characteristics can include color, saturation, and gray-scale level.

In one embodiment, the controller 21 includes a microcontroller, CPU, or other logic device to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the controller 21 or other components.

The driver controller 29 takes the raw image data generated by the controller 21 either directly from the controller 21 or from the frame buffer 28 and reformats the raw image data appropriately for high speed transmission to the display controller 120. Specifically, the driver controller 29 reformats the raw image data into a data flow having a raster-like format, such that it has a time order suitable for scanning across the display array 30. Then the driver controller 29 sends the formatted information to the display controller 120. Although a driver controller 29, such as a LCD controller, is often associated with the system controller 21 as a stand-alone Integrated Circuit (IC), such controllers may be implemented in many ways. For example, they may be embedded in the controller 21 as hardware, embedded in the controller 21 as software, or fully integrated in hardware with the display controller 120.

The display controller 120 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, display controller 120, and display array 30 are appropriate for any of the types of displays described herein. For example, in one embodiment, driver controller 29 is a conventional display controller or a bi-stable display controller (e.g., an interferometric modulator controller). In another embodiment, display controller 120 is a conventional driver or a bi-stable display driver (e.g., an interferometric modulator display). In one embodiment, a driver controller 29 is integrated with the display controller 120. Such an embodiment is common in highly integrated systems such as cellular phones, watches, and other small area displays. In yet another embodiment, display array 30 is a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the display controller 120. The above-described optimization may be implemented in any number of hardware and/or software components and in various configurations.

Returning to FIG. 2, in another alternative embodiment, the processing modules associated with the graphics processor 108, such as block-based encoder 212, tag ID generator 216, and frame buffers 112a-c are situated in a first device, such as a server computer in a server-based data processing network. In this embodiment, the display controller 120, display 124, tag ID reader 224, and block-based decoder 220, are situated in a second device, such as a client computer in the data processing network, separate from the first device. In this embodiment, the display interface 116 can be implemented between the server and client as one or more communications lines comprising the network. The graphics processor 108 in the host, i.e., server device is configured to send data to the display controller 120 in the client device in similar fashion as described above with respect to FIGS. 1-6. In some embodiments, the display interface 116 is implemented as a wireless interface between the server and client devices of the network. Significant power savings can be achieved in such embodiments, since the energy cost-per-bit of sending data wirelessly is generally greater than that in a wired configuration.

Although illustrative embodiments and applications are shown and described herein, many variations and modifications are possible which remain within the concept, scope, and spirit, and these variations should become clear after perusal of this application. Accordingly, the present embodiments are to be considered as illustrative and not restrictive, and the application is not to be limited to the details given herein, but may be modified within the scope and equivalents of the appended claims.

What is claimed is:

1. An apparatus comprising:
a graphics processor configured to receive frames of video data, each frame including a plurality of blocks of the video data, the graphics processor configured to: i) encode each block of video data, and ii) generate a tag ID associated with each encoded block of video data, the graphics processor configured to output each encoded block of video data and associated tag ID;
a display interface in communication with the graphics processor;
a display controller in communication with the display interface, the display controller configured to receive the encoded blocks of video data and associated tag ID's from the graphics processor via the display interface, the display controller configured to: i) interpret the tag ID associated with a respective encoded block of video data, and ii) determine whether to decode at least part of the respective encoded block of video data according to the tag ID; and
a display in communication with the display controller, the display configured to receive decoded blocks of video data from the display controller, the display configured to display the decoded blocks of video data.

2. The apparatus of claim 1, the tag ID including one or more indications selected from the group consisting of: a start of a new frame of video data, a redundant frame of video data, a start of a new block of video data, and a redundant block of video data.

3. The apparatus of claim 1, the display controller configured to decode the encoded block of video data if the tag ID indicates a start of a new block of video data.

4. The apparatus of claim 1, the display controller configured to disregard the encoded block of video data if the tag ID indicates a start of a redundant block of video data.

5. The apparatus of claim 4, the display controller configured to output a previous decoded block of video data.

6. The apparatus of claim 1 further comprising:
a memory in communication with the display controller, the memory capable of storing the decoded blocks of video data.

7. The apparatus of claim 1, the graphics processor configured to encode the blocks of video data using a Run Length Encoding (RLE) process.

8. The apparatus of claim 1, the graphics processor configured to encode the blocks of video data using an Arithmetic Coding (AC) process.

9. The apparatus of claim 1, the graphics processor configured to encode the blocks of video data using a Huffman Coding (HC) process.

10. The apparatus of claim 1, the display being a memory display.

11. The apparatus of claim 10, the memory display being a bi-stable display.

12. The apparatus of claim 11, the bi-stable display being one selected from the group consisting of: an interferometric modulation display (IMOD), a cholesteric liquid crystal display (ChLCD), and an electrophoretic display.

13. The apparatus of claim 1, the frames of video data being stored in one or more frame buffers, the graphics processor configured to receive the frames of video data from the one or more frame buffers.

14. The apparatus of claim 1, the display interface configured to pass the encoded blocks of video data using a standard selected from the group consisting of: the Mobile Industry Processor Interface (MIPI) standard, the Mobile Display Digital Interface (MDDI) standard, the Low-Voltage Differential Signaling (LVDS) standard, and the High-Definition Multimedia Interface (HDMI) standard.

15. The apparatus of claim 1 further comprising:
an encoder configured to encode each block of video data.

16. The apparatus of claim 1 further comprising:
a decoder configured to decode the at least part of the respective encoded block of video data according to the tag ID.

17. The apparatus of claim 1 further comprising:
a tag ID generator configured to generate the tag ID associated with each encoded block of video data.

18. The apparatus of claim 1 further comprising:
a tag ID reader configured to interpret the tag ID associated with the respective encoded block of video data.

19. The apparatus of claim 1, the graphics processor configured to output a packet including a respective encoded block of video data and associated tag ID.

20. The apparatus of claim 19, the associated tag ID located at a beginning of the packet.

21. The apparatus of claim 19, the packet further including an indication of a number of bytes of data.

22. The apparatus of claim 1 further comprising:
a driver circuit configured to send at least one signal comprising the decoded blocks of video data to the display.

23. The apparatus of claim 22, the display controller configured to send the decoded blocks of video data to the driver circuit.

24. The apparatus of claim 1 further comprising:
an image source module configured to send the frames of video data to the graphics processor.

25. The apparatus of claim 24, the image source module comprising at least one of a receiver, a transceiver, and a transmitter.

26. The apparatus of claim 1 further comprising:
an input device configured to receive input data and to communicate the input data to a controller.

27. The apparatus of claim 1, the graphics processor situated in a server device.

28. The apparatus of claim 1, the display controller situated in a client device.

29. The apparatus of claim 28, the display situated in the client device.

30. A method comprising:
receiving frames of video data at a graphics processor, each frame including a plurality of blocks of the video data;
encoding each block of video data;
generating a tag ID associated with each encoded block of video data;
providing each encoded block of video data and associated tag ID from the graphics processor to a display interface in communication with the graphics processor;
receiving the encoded blocks of video data and associated tag ID's at a display controller in communication with the display interface;
interpreting the tag ID associated with a respective encoded block of video data;
determining whether to decode at least part of the respective encoded block of video data according to the tag ID; and
providing decoded blocks of video data from the display controller to a display in communication with the display controller, the display configured to display the decoded blocks of video data.

31. The method of claim 30 further comprising:
decoding the encoded block of video data if the tag ID indicates a start of a new block of video data.

32. The method of claim 30 further comprising:
disregarding the encoded block of video data if the tag ID indicates a start of a redundant block of video data.

33. The method of claim 30 further comprising:
outputting a previous decoded block of video data if the tag ID indicates a start of a redundant block of video data.

34. The method of claim 30, encoding each block of video data comprising:
encoding the block of video data using a Run Length Encoding (RLE) process.

35. The method of claim 30, providing each encoded block of video data and associated tag ID from the graphics processor to the display interface comprising:
outputting a packet including a respective encoded block of video data and associated tag ID.

36. The method of claim 30, generating the tag ID associated with each encoded block of video data comprising:
performing a compare operation between successive blocks of video data.

37. The method of claim 30, the graphics processor situated in a server device.

38. The method of claim 30, the display controller situated in a client device.

39. An apparatus comprising:
graphics processor means for receiving frames of video data, each frame including a plurality of blocks of the video data, and i) encoding each block of video data, and ii) generating a tag ID associated with each encoded block of video data, and outputting each encoded block of video data and associated tag ID;
display interface means in communication with the graphics processor means;
display controller means in communication with the display interface means, the display controller means for receiving the encoded blocks of video data and associated tag ID's from the graphics processor means via the display interface means, and: i) interpreting the tag ID associated with a respective encoded block of video data, and ii) determining whether to decode at least part of the respective encoded block of video data according to the tag ID; and
display means in communication with the display controller means, the display means for receiving decoded blocks of video data from the display controller means and displaying the decoded blocks of video data.

40. The apparatus of claim 39, the graphics processor situated in a server device.

41. The apparatus of claim 39, the display controller situated in a client device.

42. The apparatus of claim 41, the display situated in the client device.

43. A method comprising:
receiving frames of video data at a graphics processor, each frame including a plurality of blocks of the video data;
encoding each block of video data;
generating a tag ID associated with each encoded block of video data; and
providing each encoded block of video data and associated tag ID from the graphics processor to a display interface in communication with the graphics processor.

44. The method of claim 43, the graphics processor situated in a server device.

45. The method of claim 43, the tag ID including one or more indications selected from the group consisting of: a start of a new frame of video data, a redundant frame of video data, a start of a new block of video data, and a redundant block of video data.

46. The method of claim 43, providing each encoded block of video data and associated tag ID from the graphics processor to the display interface comprising:
outputting a packet including a respective encoded block of video data and associated tag ID.

47. The method of claim 43, generating the tag ID associated with each encoded block of video data comprising:
performing a compare operation between successive blocks of video data.

48. A method comprising:
receiving encoded blocks of video data and tag ID's at a display controller from a display interface, each of the encoded blocks having a respective associated tag ID;
interpreting the tag ID associated with a respective encoded block of video data;
determining whether to decode at least part of the respective encoded block of video data according to the tag ID; and
providing decoded blocks of video data from the display controller to a display in communication with the display controller, the display configured to display the decoded blocks of video data.

49. The method of claim 48, the display controller situated in a client device.

50. The method of claim 48 further comprising:
decoding the encoded block of video data if the tag ID indicates a start of a new block of video data.

51. The method of claim 48 further comprising:
disregarding the encoded block of video data if the tag ID indicates a start of a redundant block of video data.

52. The method of claim 48 further comprising:
outputting a previous decoded block of video data if the tag ID indicates a start of a redundant block of video data.
